(19) United States
(12) Patent Application Publication
(10) Pub. No.: US 2020/0081563 A1
(43) Pub. Date: Mar. 12, 2020

(54) TOUCH PANEL AND METHOD FOR MAKING THE SAME

(71) Applicants: Interface Technology (ChengDu) Co., Ltd., Chengdu (CN); INTERFACE OPTOELECTRONICS (SHENZHEN) CO., LTD., Shenzhen (CN); GENERAL INTERFACE SOLUTION LIMITED, Zhunan (TW)

(72) Inventors: JIN-LI WANG, Hsinchu (TW); CHUN-LIN TSENG, Hsinchu (TW)

(21) Appl. No.: 16/246,812

(22) Filed: Jan. 14, 2019

(30) Foreign Application Priority Data
Sep. 10, 2018 (CN) 201811051347.3

(51) Int. Cl. G06F 3/041

(52) U.S. Cl. CPC G06F 3/041; G06F 2203/04103

(57) ABSTRACT

A touch panel in an electronic device proofed against deterioration caused by repeated flexion cracking or otherwise damaging fine wire traces defines a touch area and a trace area surrounding the touch area. The touch panel includes a substrate and fine wire traces formed on the substrate and located in the trace area. One or more metal layers are applied to cover each trace, providing durability against flexion and improving basic conductivity of the traces. A method for making the touch panel is also provided. By providing a metal layer or several metal layers on each trace, a performance of each trace is improved.

### FIELD

The subject matter herein generally relates to touch panels and methods for making same.

### BACKGROUND

A touch panel generally includes touch electrodes located in a touch area and traces located in a trace area surrounding the touch area. The traces are electrically connected to the touch electrodes. In order to obtain a narrow-frame touch panel, the traces made of copper or copper alloy formed by sputtering are commonly used to meet the demand for thinner line widths. However, compared with gold or silver with good ductility, flex-resistance of copper metal is low. After repeated deflections, a surface of the copper trace can crack, and a line resistance value will increase by about 5-10%. Electrical instability in a device utilizing the touch panel will be the result.

Therefore, there is room for improvement in the art.

### BRIEF DESCRIPTION OF THE DRAWINGS

Implementations of the present disclosure will now be described, by way of example only, with reference to the attached figures.

FIG. 1 is a cross-sectional view showing a display panel according to a first embodiment.

FIGS. 2A through 2B are cross-sectional views showing steps in a method of making the touch panel according to the first embodiment.

FIG. 3 is a cross-sectional view showing a display panel according to a second embodiment.

FIGS. 4A through 4C are cross-sectional views showing steps in a method of making the touch panel according to the second embodiment.

FIGS. 5A through 5G are cross-sectional views showing a trace and at least one metal layer covering the trace.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. The term “circuit” is defined as an integrated circuit (IC) or other circuit with electronic elements, such as capacitors, resistors, amplifiers, and the like.

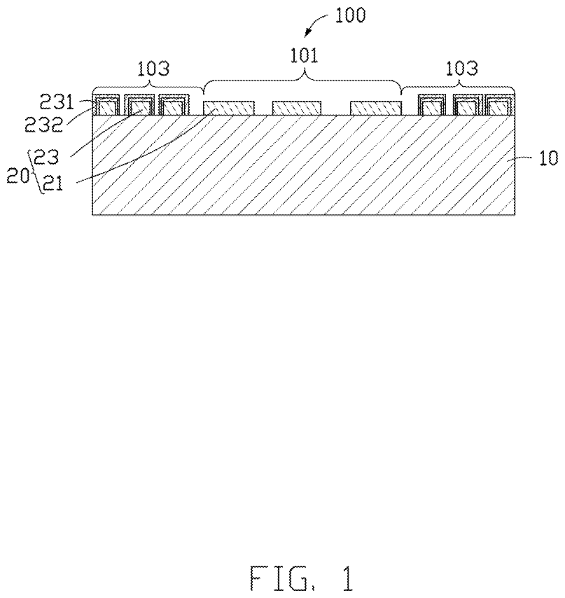

FIG. 1 illustrates an embodiment of a touch panel 100 defining a touch area 101 and a trace area 103 surrounding the touch area 101. The touch panel 100 includes a substrate 10 and a transparent conductive layer 20 formed on the substrate 10. The substrate 10 may be flexible. The transparent conductive layer 20 is formed in the touch area 101 and the trace area 103.

The transparent conductive layer 20 includes touch electrodes 21 located in the touch area 101 and traces 23 located in the trace area 103. The traces 23 are electrically connected to the touch electrodes 21. In this embodiment, a material of the transparent conductive layer 20 (including the touch electrodes 21 and the traces 23) is a transparent electrically conductive material containing nano silver wires, nano copper wires, conductive polymer, carbon nanotube, graphene, or a combination of the above materials. In an embodiment, the material of the transparent conductive layer 20 is a transparent electrically conductive material containing metal silver such as nano silver wires or nano silver particles.

Each trace 23 may also be covered with at least one metal conductive layer, and the metal conductive layer improves the conductivity of the traces 23. As shown in FIG. 1, a surface of the trace 23 is covered with a first metal layer 231. In an embodiment, a material of the first metal layer 231 is a metal having good ductility (or a fold-resistant metal), such as at least one of gold, silver, and nickel. The fold-resistance of the traces 23 is improved overall.

When the first metal layer 231 contains a metal that easily migrates and diffuses, such as silver, a second metal layer 232 (shown in FIG. 1) selectively covering the first metal layer 231 prevents such migration or diffusion. In an embodiment, a material of the second metal layer 232 may be copper or a copper alloy.

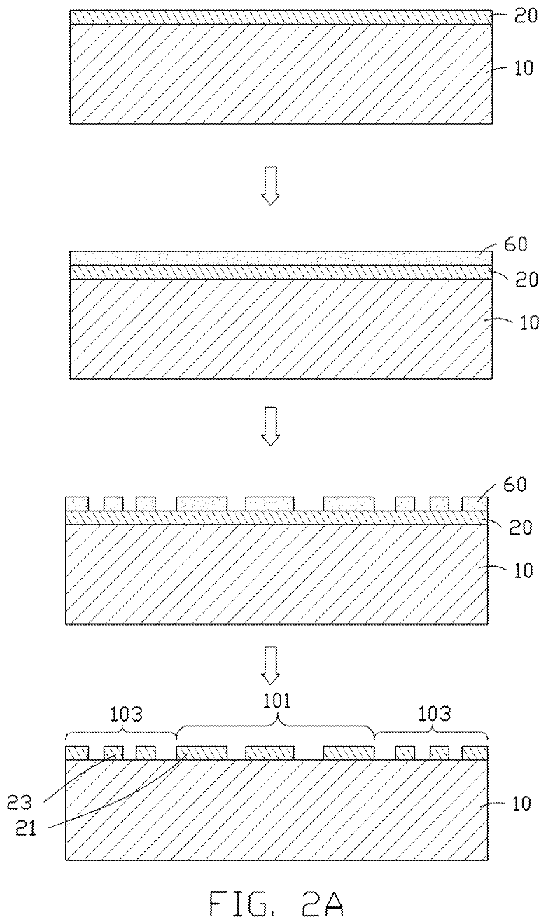

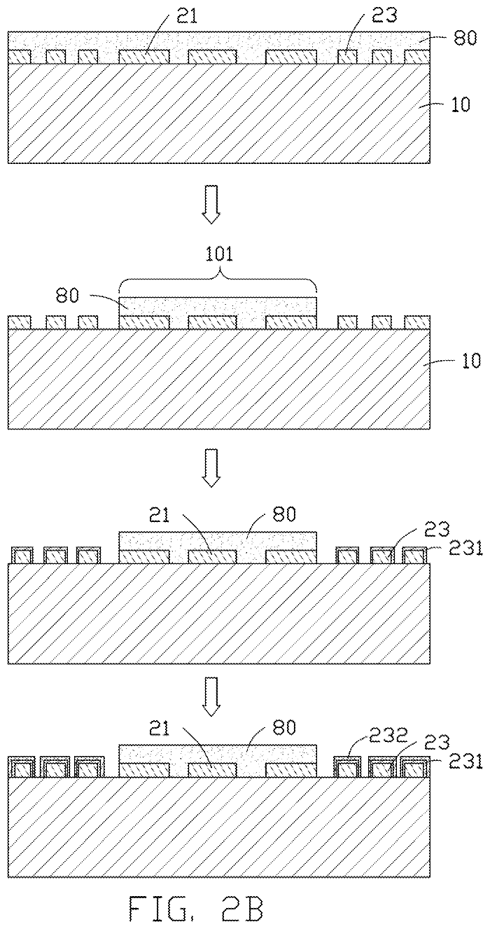

FIGS. 2A and 2B are cross-sectional views showing a method of making the touch panel 100 according to the first embodiment. The method includes the following steps.

Step S1: a substrate 10 and forming a transparent conductive layer 20 is provided on a surface of the substrate 10 in relation to FIG. 2A.

The substrate 10 may be flexible. The material of the transparent conductive layer 20 is a conductive material containing metal silver such as nano silver wires or nano silver particles. Specifically, the step coats an ink containing nano silver wires or nano silver particles onto the substrate 10, and dries the same to form the transparent conductive layer 20.

Step S2: patterning the transparent conductive layer 20 to form touch electrodes 21 spaced from each other and traces 23 connecting to the touch electrodes 21 is provided in relation to FIG. 2A.

The touch electrodes 21 define a touch area 101 located at the center, and the traces 23 define a trace area 103 surrounding the touch area 101.

The step, as shown in FIG. 2A, forms a photoresist layer 60 on a surface of the transparent conductive layer 20 away from the substrate 10, and exposing and developing the photoresist layer 60 so that the photoresist layer 60 partially covers the surface of the transparent conductive layer 20. A portion of the transparent conductive layer 20 is etched away to be exposed to the photoresist layer 60. The transparent conductive layer 20 is etched with the photoresist layer 60 as a mask, and portion of the transparent conductive layer 20 not covered by the photoresist layer 60 is etched away. The portion of the transparent conductive layer 20 covered by the photoresist layer 60 is retained. In an embodiment, the transparent conductive layer 20 may be etched using a yellow light process, a wet etching process, or a laser etching process.

In this method, the touch electrodes 21 and the traces 23 may be formed in one patterning step. In an embodiment, the trace 23 has a line width of 5-30 microns and a line space of 5-30 microns. This method achieves a fine line width.

Step S3: forming of an insulating shielding layer 80 covering the touch electrodes 21 (in touch area 101) is illustrated in relation to FIG. 2B.

This step forms the insulating shielding layer 80 on the substrate 10 to cover the touch area 101 and the trace area 103 (the touch electrodes 21 and the traces 23 are covered). The insulating shielding layer 80 is exposed and developed, such that the insulating shielding layer 80 covers only the touch area 101.

Step S4: forming of a first metal layer 231 to cover the exposed traces 23 with the insulating layer 80 as a shield is illustrated in relation to FIG. 2B.

In an embodiment, the first metal layer 231 may be directly deposited on the traces 23 by chemical plating, electroplating, or chemical displacement using a catalytic activity of the silver material itself in the traces 23. In this embodiment, the material of the first metal layer 231 is metal having good ductility, such as gold, silver, nickel, or a combination. The material of the first metal layer 231 may be selected by a type of plating solution, and a thickness or an impedance value of the first metal layer 231 may be adjusted by changing parameters of the coating, such as period of time, temperature, and plating solution concentration.

Step S5: selective forming of a second metal layer 232 covering the first metal layer 231 and selective removing of the insulating mask layer 80.

The second metal layer 232 prevents migration and diffusion of the silver or other metal atoms in the traces 23 and the first metal layer 231. In an embodiment, the material of the second metal layer 232 may be copper or a copper alloy.

By removing the insulating mask layer 80 provided on the substrate 10 and the touch panel 100, the result shown in FIG. 1 is obtained. When a material of the insulating shielding layer 80 is a transparent insulating material, the insulating shielding layer 80 may remain in the touch area 101 without being removed. When the insulating shielding layer 80 remains, the touch area 101 and the trace area 103 have a certain height difference, in which the height difference is about 1-20 micrometers (corresponding to a thickness of the insulating shielding layer 80). An inclination angle of the height difference is 0-90 degrees.

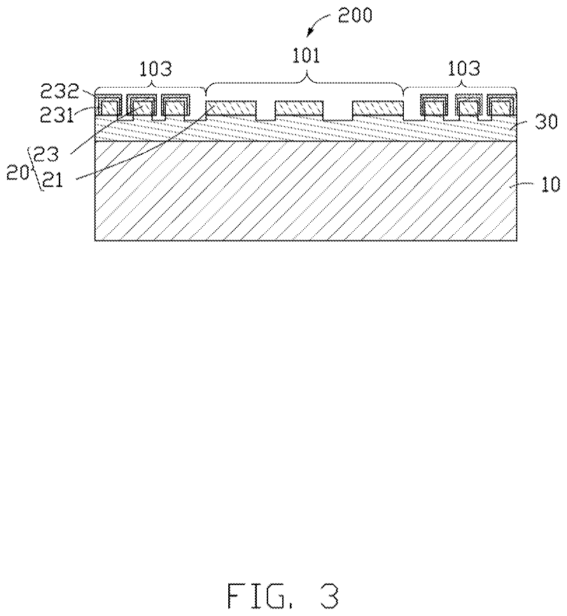

FIG. 3 shows a touch panel 200 of a second embodiment including a substrate 10, a transparent insulating photoresist layer 30 formed on the surface of the substrate 10, and a transparent conductive layer 20 formed on a surface of the transparent insulating photoresist layer 30 away from the substrate 10. The substrate 10 may be flexible. The touch panel 100 defines a touch area 101 and a trace area 103 surrounding the touch area 101. The transparent conductive layer 20 is formed in the touch area 101 and the trace area 103.

The transparent conductive layer 20 includes touch electrodes 21 located in the touch area 101 and traces 23 located in the trace area 103. The traces 23 are electrically connected to the touch electrodes 21.

In this embodiment, the material of the transparent conductive layer 20 (including the touch electrodes 21 and the traces 23) is a transparent electrically conductive material containing nano silver wires, nano copper wires, conductive polymer, carbon nanotube, graphene, or a combination of the above materials. In an embodiment, the material of the transparent conductive layer 20 is a transparent electrically conductive material containing metal silver such as nano silver wires or nano silver particles.

Each trace 23 may also be covered with at least one metal conductive layer. The trace 23 with at least one metal layer covering it has a line width of 5-30 microns, a line space of 5-30 microns, a total thickness of 0.1-5 microns, and an impedance value of 0.1-150 Ohm/sq.

In this embodiment, a surface of the trace 23 not covered by the transparent insulating photoresist layer 30 is covered with a first metal layer 231. In this embodiment, a material of the traces 23 is a transparent conductive material containing nano silver wires, nano copper wires, conductive polymer, carbon nanotube, graphene, or a combination of the above materials. In an embodiment, the material of the traces 23 is a transparent conductive material containing metal silver such as nano silver wires or nano silver particles. In an embodiment, the material of the first metal layer 231 is a metal having good ductility, such as at least one of gold, silver, and nickel. In other embodiments, the material of the first metal layer 231 may be other conductive metals, not limited to being a fold-resistant metal.

When the first metal layer 231 contains a metal that is easily migrates and diffuses, a second metal layer 232 (shown in FIG. 3) covering layer 231 prevents a migration or a diffusion of metal atoms such as silver atoms in the traces 23 and the first metal layer 231. The material of the second metal layer 232 may be copper or a copper alloy.

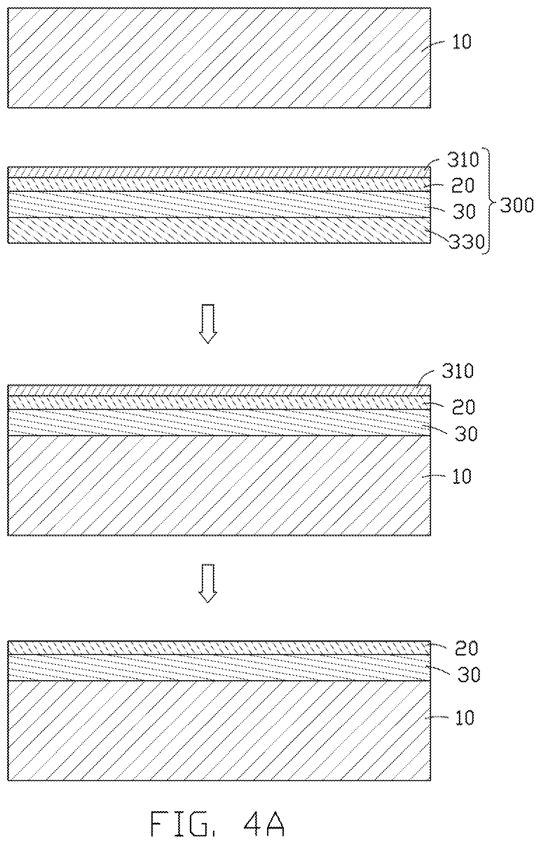

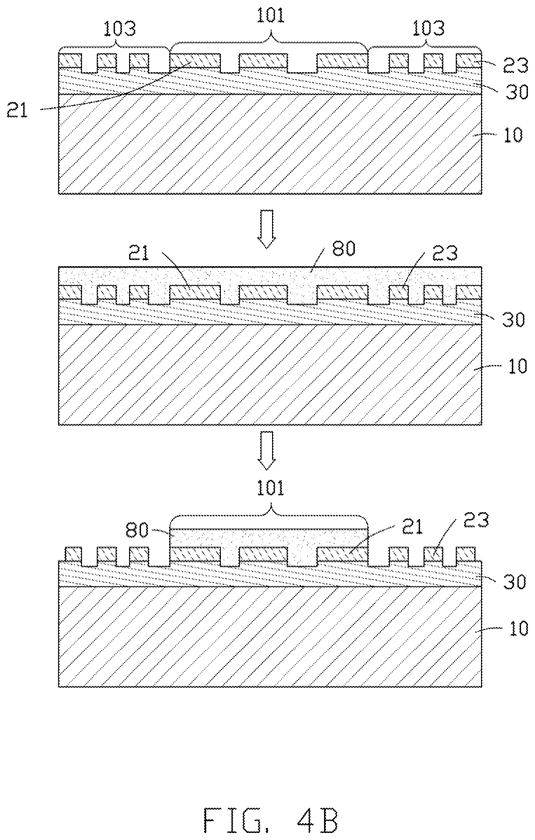

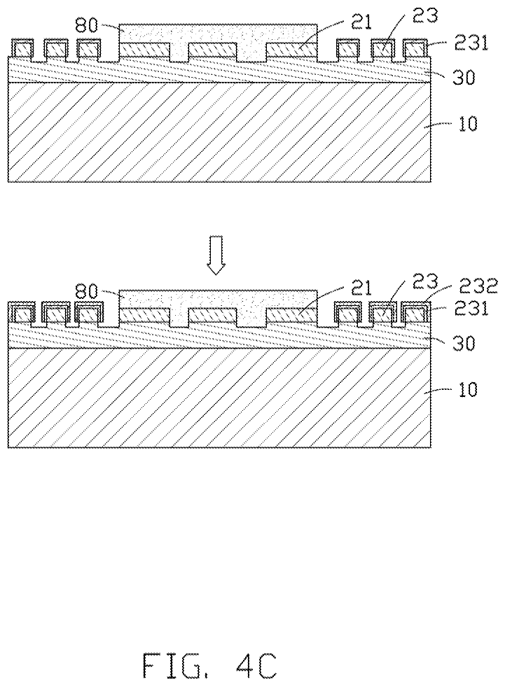

FIGS. 4A through 4C are cross-sectional views showing a method of making the touch panel 200 according to the second embodiment. The method includes the following steps.

Step S1: providing of a substrate 10 and a repost transparent conductive film 300, and attaching the repost transparent conductive film 300 to a surface of the substrate 10 are illustrated in relation to FIG. 4A.

As shown in FIG. 4A, the repost transparent conductive film 300 includes a transparent insulating photoresist layer 30, a transparent conductive layer 20 formed on the transparent insulating photoresist layer 30, and a carrier film 310 formed on a side of the transparent conductive layer 20 away from the transparent insulating resist layer 30. A protective film 330 is also formed on a side of the transparent insulating resist layer 30 away from the transparent conductive layer 20. In an embodiment, the material of the transparent conductive layer 20 is metal silver such as nano silver wires or nano silver particles. The carrier film 310 and the protective film 330 protect the transparent insulating photoresist layer 30 and the transparent conductive layer 20, which are discarded before actual use begins.

The substrate 10 may be flexible. Step S1 as shown in FIG. 4A, peels off the protective film 330 of the repost transparent conductive film 300, and attaches the repost transparent conductive film 300 to a surface of the substrate 10 by a hot pressing method. The transparent insulating photoresist layer 30 is directly applied to the substrate 10. Then, in a direction away from the substrate 10, the transparent insulating photoresist layer 30, the transparent conductive layer 20, and the carrier film 310 are sequentially laminated. The carrier film 310 is then peeled off to expose the transparent conductive layer 20.

Step S2: patterning of the transparent conductive layer 20 to form touch electrodes 21 spaced from each other and traces 23 connecting the touch electrodes 21 is illustrated in relation to FIG. 4B.

The touch electrodes 21 define a touch area 101 located at the center, and the traces 23 define a trace area 103 surrounding the touch area 101.

Step S2 forms a photoresist layer (not shown) on a surface of the transparent conductive layer 20 away from the substrate 10 and the photoresist layer is exposed and developed so that the photoresist layer partially covers the surface of the transparent conductive layer 20. The portion of the transparent conductive layer which is to be etched away is exposed to the photoresist layer. The portion of the transparent conductive layer 20 that is not covered by the photoresist layer is etched with the photoresist layer as a mask, and a portion of the transparent conductive layer 20 covered by the photoresist layer is retained. In an embodiment, the transparent conductive layer 20 may be etched using a yellow light process, a wet etching process, or a laser etching process.

In the above described method, the touch electrodes 21 and the traces 23 may be formed in one patterning step. In an embodiment, the trace 23 has a line width of 5-30 microns and a line space of 5-30 microns. This method achieves a fine line width.

Step S3: forming of an insulating shielding layer 80 covering the touch electrodes 21 (in the touch area 101) is illustrated in relation to FIG. 4B.

The step includes: forming the insulating shielding layer 80 on the substrate 10 covering the touch area 101 and the trace area 103 (the touch electrode 21 and the trace 23 are covered); and exposing and developing the insulating shielding layer 80, such that the insulating shielding layer 80 covers only the touch area 101.

Step S4: forming of a first metal layer 231 which covers exposed traces 23 with the insulating layer 80 as a shield is illustrated in relation to FIG. 4B.

The first metal layer 231 may be deposited on the trace 23 by chemical plating, electroplating, or chemical displacement using a catalytic activity of the silver material itself in the trace 23. In an embodiment, the material of the first metal layer 231 is a metal having good ductility, such as at least one of gold, silver, and nickel or a combination.

Step S5: selective forming of the second metal layer 232 covering the first metal layer 231 and selective removing of the insulating mask layer 80 on the substrate 10 are illustrated.

The second metal layer 232 prevents migration and diffusion of the metal atoms (such as silver atoms) in the traces 23 and the first metal layer 231. In an embodiment, the material of the second metal layer 232 may be copper or a copper alloy.

FIG. 3 illustrates removing of the insulating mask layer 80 on the substrate 10 results in the touch panel 200. When the material of the insulating shielding layer 80 is a transparent insulating material, the insulating shielding layer 80 may remain in the touch area 101 without being removed.

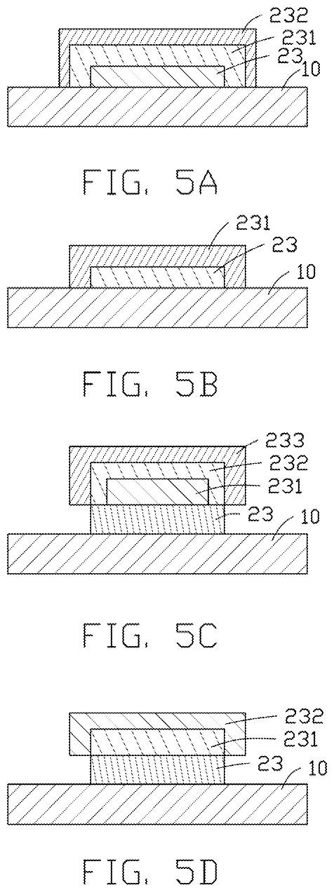

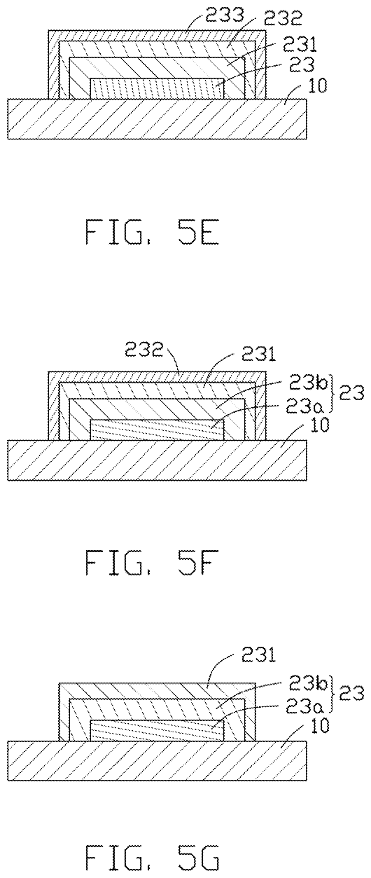

The trace 23 and at least one metal layer covering it are not limited to be the structures shown in FIGS. 1 and 3. The structures shown in FIGS. 5A to 5G may be included. In the structures shown in FIGS. 5A and 5B, the material of the traces 23 is a conductive metal. In the structures shown in FIGS. 5C, 5D, and 5E, the material of the traces 23 is a transparent conductive material. In the structures shown in FIGS. 5F and 5Q the traces 23 includes a catalyst layer 23a formed on the substrate 10. In the structures of FIG. 1, FIG. 3 and FIG. 5A to FIG. 5Q a metal layer is located on the traces 23. In an embodiment, the metal layer is a fold-resistant metal layer, and the resistance against folding of the metal layer is higher than that of the traces 23 alone, to improve the overall folding resistance of the traces 23.

As shown in FIG. 5A, surfaces of the trace 23 not covered by the substrate 10 are covered with the first metal layer 231, and surfaces of the first metal layer 231 are covered with the second metal layer 232. In an embodiment, the material of the trace 23 may be copper or a copper alloy. The material of the first metal layer 231 is a metal having good ductility (or a fold-resistant metal), such as at least one of gold, silver, and nickel or a combination. The material of the second metal layer 232 may be copper or a copper alloy. The second metal layer 232 covers all surfaces of the first metal layer 231 that are not covered by the traces 23 to prevent migration and diffusion of atoms out of the first metal layer 231. In an embodiment, the material of the trace 23 and the material of the second metal layer 232 may be the same or different.

As shown in FIG. 5B, surfaces of the trace 23 not covered by the substrate 10 are covered with the first metal layer 231. In an embodiment, the material of the trace 23 is a metal having good ductility, such as at least one of metal gold, silver, and nickel. The material of the first metal layer 231 may be copper or a copper alloy. The first metal layer 231 prevents migration and diffusion of atoms in the traces 23.

As shown in FIG. 5C, a surface of the trace 23 away from the substrate 10 is covered with a first metal layer 231. The surface of the trace 23 away from the substrate 10 is further covered with a second metal layer 232 covering the first metal layer 231, and surfaces of a second metal layer 232 are covered with a third metal layer 233. In this embodiment, the material of the trace 23 is a transparent conductive material. In one embodiment, the material of the trace 23 is a conductive material containing metal silver such as nano silver wires or nano silver particles. The material of the first metal layer 231 may be copper or a copper alloy. The material of the second metal layer 232 is a metal having good ductility, such as at least one of metal gold, silver, and nickel. The material of the third metal layer 233 is copper or a copper alloy. The third metal layer 233 prevents migration and diffusion of atoms in the second metal layer 232. The first metal layer 231 covers one surface of the trace 23, the second metal layer 232 covers surfaces of the first metal layer 231, and the third metal layer 233 covers surfaces of the second metal layer 232.

As shown in FIG. 5D, a surface of the trace 23 away from the substrate 10 is covered with a first metal layer 231, and surfaces of the first metal layer 231 not covered by the trace 23 are covered with a second metal layer 232. In this embodiment, the material of the trace 23 is a transparent conductive material. In an embodiment, the material of the trace 23 is a transparent conductive material containing metal silver such as nano silver wires or nano silver particles. The material of the first metal layer 231 is a metal having good ductility, such as at least one of metal gold, silver, and nickel. The material of the second metal layer 232 is copper or a copper alloy. The second metal layer 232 prevents migration and diffusion of atoms in the first metal layer 231. The first metal layer 231 covers one surface of the trace 23, and the second metal layer 232 covers surfaces of the first metal layer 231.

As shown in FIG. 5E, surfaces of the trace 23 not covered by the substrate 10 are covered with a first metal layer 231, and surfaces of the first metal layer 231 not covered by the trace 23 are covered with a second metal layer 232. Surfaces of the second metal layer 232 not covered by the first metal layer 231 are covered with a third metal layer 233. In this embodiment, the material of the trace 23 is a transparent conductive material. In an embodiment, the material of the trace 23 is a conductive material containing metal silver such as nano silver wires or nano silver particles. The material of the first metal layer 231 is copper or a copper alloy. The material of the second metal layer 232 is a metal having good ductility, such as at least one of metal gold, silver, and nickel. The material of the third metal layer 233 is copper or a copper alloy. The first metal layer 231 covers surfaces of the trace 23, the second metal layer 232 covers surfaces of the first metal layer 231, and the third metal layer covers surfaces of the second metal layer 232. The third metal layer 233 prevents migration and diffusion of atoms out of the second metal layer 232.

As shown in FIG. 5F, surfaces of the trace 23 not covered by the substrate 10 are covered with a first metal layer 231, and surfaces of the first metal layer 231 not covered by the trace 23 are covered with a second metal layer 232. In this embodiment, the trace 23 is formed by conversion of a chemical catalyst layer. The trace 23 includes a catalyst layer 23a formed on a surface of the substrate 10 and a conductive layer 23b covering surfaces of the catalyst layer 23a not covered by the substrate 10. The conductive layer 23b covers surfaces of the catalyst layer 23a. A material of the catalyst layer 23a is an ink or a photoresist containing a conductive metal such as palladium or silver. The conductive layer 23b may be formed by chemical plating of the catalyst layer 23a, and is made of a conductive metal in the catalyst layer 23a. The material of the first metal layer 231 is a metal having good ductility, such as at least one of metal gold, silver, and nickel. The material of the second metal layer 232 is copper or a copper alloy. The first metal layer 231 covers surfaces of the conductive layer 23b, and the second metal layer 232 covers surfaces of the first metal layer 231. The second metal layer 232 prevents migration and diffusion of atoms in the first metal layer 231.

As shown in FIG. 5G surfaces of the trace 23 not covered by the substrate 10 are covered with the first metal layer 231. In this embodiment, the trace 23 is formed by conversion of a chemical catalyst layer. The trace 23 includes a catalyst layer 23a formed on a surface of the substrate 10 and a conductive layer 23b covering surfaces of the catalyst layer 23a not covered by the substrate 10. The conductive layer 23b covers surfaces of the catalyst layer 23a. The material of the catalyst layer 23a is an ink or a photoresist containing a conductive metal such as palladium or silver. The conductive layer 23b may be formed by chemical plating of the catalyst layer 23a, and is made of a metal having good ductility, such as at least one of metal gold, silver, and nickel. The material of the first metal layer 231 is copper or a copper alloy. The first metal layer 231 covers surfaces of the conductive layer 23b. The first metal layer 231 prevents migration and diffusion of atoms in the conductive layer 23b.

A method for making the touch panel of this disclosure includes the following steps:

Step S11: providing a substrate, and forming traces on the substrate;

Step S12: forming a metal layer covering the traces, and a material of the metal layer is a fold-resistant metal having good ductility, such as at least one of a ductile metal, silver, and nickel.

Step S13: covering the metal layer with another metal layer.

In step S11, touch electrodes are also formed on the substrate. The touch electrodes and the traces may be formed by patterning a same conductive layer as described above. For example, the touch electrodes and the traces are formed by a same transparent conductive layer, and the material of the transparent conductive layer 20 is preferably a conductive material containing metal silver such as nano silver wires or nano silver particles.

In step S11, the touch electrodes and the traces may be formed by other methods. For example, the touch electrodes are formed by patterning a transparent conductive layer, and the traces are patterned by a metal conductive layer. In other embodiments, the traces may be formed by conversion using a chemical catalyst layer containing a conductive metal; therefore, the traces formed by the chemical catalyst layer may include only one layer of conductive metal (in this case, all of the chemical catalyst layers are converted into the conductive metal), or may include a chemical catalyst layer and a conductive metal layer covering the chemical catalyst layer (in this case, the chemical catalyst layer is partially converted into the conductive metal).

In addition, if the material of the traces itself is a ductile metal layer (for example, at least one of metal gold, silver, and nickel) in step S11, step S12 can be removed.

In step S12, the metal layer having good ductility can be formed by a method such as chemical plating, electroplating or chemical metal replacement.

When the metal layer having good ductility is formed by the chemical metal replacement method, an initial metal layer may be formed on the traces in advance, and then the initial metal layer is partially replaced to form the metal layer having good ductility (the initial metal layer is remained) or all the initial metal layer is replaced to form the metal layer having good ductility (the initial metal layer is not retained).

Since the traces have been patterned, subsequent metal layers may be selectively formed on the traces without a need for a subsequent yellow light processes or etching processes.

In step S13, another metal layer may be formed by a method such as chemical plating or electroplating. The step S13 is optional. For example, when the material of the metal layer in step S12 is a metal that is easily diffused and migrated, such as silver, it is necessary to perform step S13 to form the other metal layer to prevent migration and diffusion of silver.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A touch panel, defining a touch area and a trace area surrounding the touch area, the touch panel comprising:
a substrate;
a plurality of traces formed on the substrate and located in the trace area; and
a metal layer covering each of the plurality of traces.

2. The touch panel according to claim 1, wherein the metal layer comprises a first metal layer and a second metal layer covering the first metal layer, a material of the first metal layer is a fold-resistant metal, the second metal layer is configured to prevent migration and diffusion of metal atoms in the first metal layer, and the first metal layer covers all surfaces of each trace that are not covered by the substrate.

3. The touch panel according to claim 1, wherein a material of the plurality of traces is a fold-resistant metal, and the metal layer is configured to prevent migration and diffusion of metal atoms in the plurality of traces.

4. The touch panel according to claim 1, wherein the metal layer comprises a first metal layer, a second metal layer covering the first metal layer, and a third metal layer covering the second metal layer, a material of the second metal layer is a fold-resistant metal, the third metal layer is configured to prevent migration and diffusion of metal atoms in the second metal layer, and the first metal layer partially covers a surface of each trace away from of the substrate.

5. The touch panel according to claim 1, wherein the metal layer comprises a first metal layer and a second metal layer covering the first metal layer, a material of the first metal layer is a fold-resistant metal, the second metal layer is configured to prevent migration and diffusion of metal atoms in the first metal layer, and the first metal layer covers a surface of each trace away from the substrate.

6. The touch panel according to claim 1, wherein the metal layer comprises a first metal layer, a second metal layer covering the first metal layer, and a third metal layer covering the second metal layer, a material of the second metal layer is a folding-resistant metal, the third metal layer is configured to prevent migration and diffusion of metal atoms in the second metal layer, and the first metal layer covers all surfaces of each trace that are not covered by the substrate.

7. The touch panel according to claim 1, wherein each trace comprises a catalyst layer formed on the substrate and a conductive layer formed on the catalyst layer, the metal layer comprises a first metal layer covering the conductive layer and a second metal layer covering the first metal layer, a material of the first metal layer is a folding-resistant metal, and the second metal layer is configured to prevent migration and diffusion of metal atoms in the first metal layer.

8. The touch panel according to claim 1, wherein each trace comprises a catalyst layer formed on the substrate and a conductive layer formed on the catalyst layer, a material of the conductive layer is a fold-resistant metal, and the metal layer is configured to prevent migration and diffusion of metal atoms in the conductive layer.

9. The touch panel according to claim 1, wherein a transparent insulating photoresist layer is further located between the substrate and each trace, the metal layer comprises a first metal layer and a second metal layer covers the first metal layer, a material of the first metal layer is a fold-resistant metal, and the second metal layer is configured to prevent migration and diffusion of metal atoms in the first metal layer.

10. A method of making a touch panel, comprising steps of:
providing a substrate to form a plurality of traces on the substrate; and
forming a metal layer covering each of the plurality of traces.

11. The method of making a touch panel according to claim 10, wherein the metal layer comprises a first metal layer and a second metal layer covering the first metal layer, a material of the first metal layer is a fold-resistant metal, the second metal layer is configured to prevent migration and diffusion of metal atoms in the first metal layer, and the first metal layer covers all surfaces of each trace that are not covered by the substrate.

12. The method of making a touch panel according to claim 10, wherein a material of the plurality of traces is a fold-resistant metal, and the metal layer is configured to prevent migration and diffusion of metal atoms in the plurality of traces.

13. The method of making a touch panel according to claim 10, wherein the metal layer comprises a first metal layer, a second metal layer covering the first metal layer, and a third metal layer covering the second metal layer, a material of the second metal layer is a fold-resistant metal, the third metal layer is configured to prevent migration and diffusion of metal atoms in the second metal layer, and the first metal layer partially covers a surface of each trace away from of the substrate.

14. The method of making a touch panel according to claim 10, wherein the metal layer comprises a first metal layer and a second metal layer covering the first metal layer, a material of the first metal layer is a fold-resistant metal, the second metal layer is configured to prevent migration and diffusion of metal atoms in the first metal layer, and the first metal layer covers a surface of each trace away from the substrate.

15. The method of making a touch panel according to claim 10, wherein the metal layer comprises a first metal layer, a second metal layer covering the first metal layer, and a third metal layer covering the second metal layer, a material of the second metal layer is a folding-resistant metal, the third metal layer is configured to prevent migration and diffusion of metal atoms in the second metal layer, and the first metal layer covers all surfaces of each trace that are not covered by the substrate.

16. The method of making a touch panel according to claim 10, wherein each trace comprises a catalyst layer formed on the substrate and a conductive layer formed on the catalyst layer, the metal layer comprises a first metal layer covering the conductive layer and a second metal layer covering the first metal layer, a material of the first metal layer is a folding-resistant metal, and the second metal layer is configured to prevent migration and diffusion of metal atoms in the first metal layer.

17. The method of making a touch panel according to claim 10, wherein each trace comprises a catalyst layer formed on the substrate and a conductive layer formed on the catalyst layer, a material of the conductive layer is a fold-resistant metal, and the metal layer is configured to prevent migration and diffusion of metal atoms in the conductive layer.

18. The method of making a touch panel according to claim 10, wherein a transparent insulating photoresist layer is further located between the substrate and each trace, the metal layer comprises a first metal layer and a second metal layer covers the first metal layer, a material of the first metal layer is a fold-resistant metal, and the second metal layer is configured to prevent migration and diffusion of metal atoms in the first metal layer.
